(19) United States
(12) Patent Application Publication
(10) Pub. No.: US 2016/0280974 A1
(43) Pub. Date: Sep. 29, 2016

(54) METHOD FOR APPLYING DISPERSION ADHESIVES

(71) Applicant: WACKER CHEMIE AG, München (DE)

(72) Inventors: Muhammad BABAR, Burghausen (DE); Jessica SEIDEL, Zangberg (DE); Gerhard KOEGLER, Burgkirchen (DE)

(21) Appl. No.: 15/036,800

(22) PCT Filed: Dec. 15, 2014
(86) PCT No.: PCT/EP2014/077799

§ 371 Date: May 14, 2016

(30) Foreign Application Priority Data
Dec. 16, 2013 (DE) 10 2013 226 114.4

(51) Int. Cl. C09J 151/00; B05D 1/02; B05D 1/28

(52) U.S. Cl. CPC C09J 151/003; B05D 1/28; B05D 1/02

(57) ABSTRACT

Problems associates with the mechanical application of adhesives in the form of aqueous dispersions are substantially reduced by employing polyvinyl ester dispersions stabilized with both high and medium viscosity polyvinyl alcohols.

### CROSS REFERENCE TO RELATED APPLICATIONS

This application is the U.S. National Phase of PCT Appln. No. PCT/EP2014/077799 filed Dec. 15, 2014, which claims priority to German Application No. 10 2013 226 114.4 filed Dec. 16, 2013, the disclosures of which are incorporated in their entirety by reference herein.

### BACKGROUND OF THE INVENTION

1. Field of the Invention

The invention relates to methods for applying dispersion-based adhesives comprising one or more polyvinyl esters by machine application methods, more particularly production line methods, such as nozzle or roll application methods, and to polyvinyl esters in the form of aqueous dispersions or powders which are redispersible in water.

2. Description of the Related Art

Dispersion-based adhesives based on polyvinyl esters find multifarious applications, as for example in the adhesive bonding of paper or cardboard packaging for producing folding boxes, envelopes, brochures, or cigarettes. Products of this kind are customarily manufactured industrially in production line fabrication. The dispersion-based adhesives in such applications are applied to the substrate generally by machine application methods such as nozzle application systems or roll technologies. With these application methods, instances of adhesive-related fouling, caused by imprecise or uncontrolled application of adhesive, also referred to as “splashing”, lead to fabrication problems. If adhesive gets onto the conveyor belt, there may be instances of sticking of the fabricated material, resulting in machine downtime and inconvenient cleaning work. Nozzle application is frequently accompanied by conical deposits at the nozzle exit point, diverting the jet of adhesive emerging from the nozzle. This is detrimental to precise control of adhesive application and can also lead to contamination and, ultimately, to the shutdown of the unit. In nozzle application systems, the dispersion-based adhesives are supplied by pumps through line systems to a nozzle having a rapidly opening and closing valve, with switching frequencies of up to 1000/second, for example. Nozzle valve cycle frequencies of such levels subject the dispersion-based adhesives inside the nozzle to extremely high shearing forces. Suitable dispersion-based adhesives are required accordingly to have very high shear stability.

A number of emulsifier-stabilized vinyl acetate/ethylene polymer dispersions for machine application methods are known from EP-A 1889890 and also from EP-A 1887018. There continues nevertheless to be a need for dispersion-based adhesives which even better meet the requirements of machine application methods.

Against this background, the problem addressed was that of providing new measures by means of which one or more of the abovementioned problems in the application of dispersion-based adhesives by machine application methods can be avoided or reduced.

### SUMMARY OF THE INVENTION

The invention provides methods for applying adhesives in the form of aqueous dispersions (“dispersion-based adhesives”) comprising one or more polyvinyl esters and optionally one or more additives, by machine application methods, characterized in that

the polyvinyl esters are stabilized with at least two polyvinyl alcohols,

at least one polyvinyl alcohol having a viscosity of 36 to 60 mPas (“high-viscosity polyvinyl alcohol”) and

at least one polyvinyl alcohol having a viscosity of 19 to 35 mPas (“medium-viscosity polyvinyl alcohol”).

Further provided by the invention are polyvinyl esters in the form of aqueous dispersions or water-redispersible powders, characterized in that the polyvinyl esters are stabilized with

at least two polyvinyl alcohols,

at least one polyvinyl alcohol having a viscosity of 36 to 60 mPas (high-viscosity polyvinyl alcohol) and

at least one polyvinyl alcohol having a viscosity of 19 to 35 mPas (medium-viscosity polyvinyl alcohol)

where all of the medium-viscosity polyvinyl alcohols have a degree of hydrolysis of ≦94% and

1 to 30 wt %, based on the total weight of the polyvinyl alcohols, are high-viscosity polyvinyl alcohols.

Dispersions or powders of polyvinyl esters of this kind are especially suitable for the method of the invention and for solving the problems addressed by the invention.

### DETAILED DESCRIPTION OF THE PREFERRED EMBODIMENTS

The figures for the viscosities of polyvinyl alcohols relate in the present patent application to the Höppler viscosity, determined in each case at 20° C. to DIN 53015 in 4% strength aqueous solution.

The high-viscosity polyvinyl alcohol preferably has a viscosity preferably of 38 to 55 mPas and more preferably 40 to 55 mPas. The fraction of the high-viscosity polyvinyl alcohols is preferably 1 to 30 wt %, more preferably 2 to 20 wt %, most preferably 3 to 10 wt %, based in each case on the total weight of the polyvinyl alcohols. The fraction of the high-viscosity polyvinyl alcohols is preferably 0.01 to 1.8 wt %, more preferably 0.1 to 1.2 wt %, most preferably 0.15 to 0.6 wt %, based in each case on the dry weight of the polyvinyl esters.

The medium-viscosity polyvinyl alcohol preferably has a viscosity of preferably 20 to 35 mPas, more preferably of 21 to 30 mPas, and most preferably of 23 to 27 mPas. The fraction of the medium-viscosity polyvinyl alcohols is preferably 30 to 99 wt %, more preferably 35 to 80 wt %, and most preferably 40 to 70 wt %, based in each case on the total weight of the polyvinyl alcohols. The fraction of the medium-viscosity polyvinyl alcohols is preferably 0.5 to 6.0 wt %, more preferably 1.0 to 5.0 wt %, and most preferably 2.0 to 4 wt %, based in each case on the dry weight of the polyvinyl esters.

The total amount of high-viscosity polyvinyl alcohols and medium-viscosity polyvinyl alcohols is preferably 0.6 to 6 wt %, more preferably 1 to 5 wt %, and most preferably 1.5 to 4.5 wt %, based in each case on the dry weight of the polyvinyl esters.

The polyvinyl ester dispersions may additionally optionally comprise one or more low-viscosity polyvinyl alcohols. Low-viscosity polyvinyl alcohols preferably have viscosities of preferably 1 to 18 mPas, more preferably of 1 to 15 mPas, yet more preferably 1 to 10 mPas, and most preferably of 2 to 8 mPas. The fraction of the low-viscosity polyvinyl alcohols is preferably 0 to 60 wt %, more preferably 10 to 50 wt %, and most preferably 20 to 40 wt %, based in each case on the total weight of the polyvinyl alcohols. The fraction of the low-viscosity polyvinyl alcohols is preferably 0 to 4.0 wt %, more preferably 0.5 to 3.5 wt %, and most preferably 1 to 3 wt %, based in each case on the dry weight of the polyvinyl esters.

In one particularly preferred embodiment, the polyvinyl esters are stabilized with at least three polyvinyl alcohols, more particularly with at least one high-viscosity polyvinyl alcohol, at least one medium-viscosity polyvinyl alcohol, and at least one low-viscosity polyvinyl alcohol.

Purely by way of clarification it is noted that high-viscosity polyvinyl alcohols, medium-viscosity polyvinyl alcohols, and low-viscosity polyvinyl alcohols are also referred to collectively as polyvinyl alcohols in the present patent application.

The polyvinyl alcohols may be in partly or fully hydrolyzed form. Partly hydrolyzed polyvinyl alcohols, in particular the medium-viscosity polyvinyl alcohols, are preferred. The degree of hydrolysis of the polyvinyl alcohols is preferably 80 to 94 mol %, more preferably 83 to 92 mol %, and most preferably 85 to 90 mol %.

The polyvinyl alcohols are preferably composed exclusively of vinyl alcohol units and vinyl acetate units. It is, however, also possible for partly hydrolyzed, hydrophobically modified polyvinyl alcohols to be used, but preferably no hydrophobically modified polyvinyl alcohols are used. Examples of such are partly hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 C atoms, dialkyl maleates and dialkyl fumarates such as diisopropyl maleate and diisopropyl fumarate, vinyl chloride, vinyl alkyl ethers such as vinyl butyl ether, and olefins such as ethene and decene. The fraction of the hydrophobic units is preferably from 0.1 to 10 wt %, based on the total weight of the partly hydrolyzed polyvinyl alcohol. Mixtures of the stated polyvinyl alcohols may also be used. Further preferred polyvinyl alcohols are partly hydrolyzed, hydrophobized polyvinyl alcohols, which are obtained by polymer-analogous reaction, as for example acetalization of the vinyl alcohol units with C₁ to C₄ aldehydes such as butyraldehyde. The fraction of the hydrophobic units is preferably 0.1 to 10 wt %, based on the total weight of the partly hydrolyzed polyvinyl acetate. The stated polyvinyl alcohols are accessible by means of methods known to the skilled person.

The polyvinyl esters are generally obtainable by radically initiated polymerization of a) one or more vinyl esters and optionally b) one or more further ethylenically unsaturated monomers.

Suitable vinyl esters a) are, for example, those of carboxylic acids having 1 to 22 C atoms, more particularly 1 to 12 C atoms. Preference is given to vinyl acetate, vinyl propionate, vinyl butyrate, vinyl 2-ethylhexanoate, vinyl laurate, 1-methylvinyl acetate, vinyl pivalate, and vinyl esters of a-branched monocarboxylic acids having 9 to 11 C atoms, as for example VeoVa9R or VeoVa10R (trade names of the company Momentive). Particularly preferred is vinyl acetate.

The vinyl esters a) are preferably used in an amount of preferably 50 to 100 wt %, more preferably 70 to 95 wt %, and most preferably 80 to 90 wt %, based in each case on the total weight of the monomers.

Selected as further ethylenically unsaturated monomers b1) are, in particular, one or more olefins, such as propylene or, preferably, ethylene.

The monomers b1) are preferably copolymerized in an amount of preferably 5 to 40 wt %, more preferably 5 to 30 wt %, and most preferably 10 to 20 wt %, based in each case on the total weight of the monomers.

As further ethylenically unsaturated monomers b2) it is also possible, optionally in combination with one or more olefins, such as ethylene, to select one or more ethylenically unsaturated monomers from the group encompassing (meth)acrylic esters, vinylaromatics, 1,3-dienes, and vinyl halides.

Suitable monomers from the group of the esters of acrylic acid or methacrylic acid are, for example, esters of unbranched or branched alcohols having 1 to 15 C atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, 2-ethylhexyl acrylate. Particularly preferred are methyl acrylate, methyl methacrylate, n-butyl acrylate, and 2-ethylhexyl acrylate.

Preferred vinylaromatics are styrene, methylstyrene, and vinyltoluene. A preferred vinyl halide is vinyl chloride. The preferred dienes are 1,3-butadiene and isoprene.

The monomers b2) are preferably copolymerized in an amount of preferably 0 to 45 wt % and more preferably 10 to 30 wt %, based in each case on the total weight of the monomers. Most preferably no monomers b2) are copolymerized.

Optionally it is possible as well for 0 to 10 wt %, more preferably 0.05 to 10 wt %, based on the total weight of the monomer mixture, of auxiliary monomers to be copolymerized. Most preferably, however, no auxiliary monomers are copolymerized. Examples of auxiliary monomers are ethylenically unsaturated mono- and dicarboxylic acids, preferably acrylic acid, methacrylic acid, fumaric acid, and maleic acid; ethylenically unsaturated carboxamides and carbonitriles, preferably acrylamide and acrylonitrile; mono- and diesters of fumaric acid and maleic acid such as the diethyl and diisopropyl esters, and also maleic anhydride, ethylenically unsaturated sulfonic acids and/or their salts, preferably vinylsulfonic acid, 2-acrylamido-2-methylpropanesulfonic acid. Further examples are precrosslinking comonomers such as polyethylenically unsaturated comonomers, as for example divinyl adipate, diallyl maleate, allyl methacrylate, triallyl isocyanurate, or triallyl cyanurate, or postcrosslinking comonomers, as for example acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide, and of N-methylolallylcarbamate. Also suitable are epoxide-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes, and vinylmethyldialkoxysilanes, where alkoxy groups present may be, for example, ethoxy and ethoxypropylene glycol ether radicals. Mention may also be made of monomers having hydroxyl or CO groups, examples being methacrylic and acrylic hydroxyalkyl esters such as hydroxyethyl, hydroxypropyl, or hydroxybutyl acrylate or methacrylate, and also compounds such as diacetoneacrylamide and acetylacetoxyethyl acrylate or methacrylate.

Preference is given to one or more polyvinyl esters selected from the group encompassing vinyl ester homopolymers, vinyl ester-ethylene copolymers, vinyl ester copolymers comprising one or more vinyl ester units and one or more further monomer units from the group encompassing vinylaromatics, vinyl halides, acrylic esters, methacrylic esters, and, optionally, ethylene.

Examples of preferred vinyl ester copolymers are based on 50 to 90 wt % of one or more vinyl esters, 10 to 20 wt % of ethylene, and optionally 1 to 40 wt % of one or more further monomers, based on the total weight of the monomers.

Preference is also given to comonomer mixtures of vinyl acetate with 10 to 20 wt % of ethylene; and to comonomer mixtures of vinyl acetate with 10 to 20 wt % of ethylene and 1 to 40 wt % of one or more further comonomers from the group of vinyl esters having 1 to 12 C atoms in the carboxylic acid radical such as vinyl propionate, vinyl laurate, vinyl esters of alpha-branched carboxylic acids having 9 to 11 C atoms such as VeoVa9, VeoVa10, VeoVa11; and to mixtures of vinyl acetate, 10 to 20 wt % of ethylene, and preferably 1 to 40 wt % of acrylic esters of unbranched or branched alcohols having 1 to 15 C atoms, more particularly n-butyl acrylate or 2-ethylhexyl acrylate; and to mixtures with 30 to 75 wt % of vinyl acetate, 1 to 30 wt % of vinyl laurate or vinyl esters of an alpha-branched carboxylic acid having 9 to 11 C atoms, and also 1 to 30 wt % of acrylic esters of unbranched or branched alcohols having 1 to 15 C atoms, more particularly n-butyl acrylate or 2-ethylhexyl acrylate, which also comprise 10 to 20 wt % of ethylene; and also to mixtures with vinyl acetate, 10 to 20 wt % of ethylene, and 1 to 60 wt % of vinyl chloride; the mixtures may also comprise the stated auxiliary monomers in the stated amounts, and the figures in wt % add up to 100 wt % in each case.

The polyvinyl esters are preferably bimodal or multimodal. The polyvinyl esters in the form of aqueous dispersions at a solids content of 50% in water preferably have a viscosity of preferably 1000 to 8000 mPas, more preferably 2000 to 7000 mPas, and most preferably 3000 to 6000 mPas (determined with a Brookfield viscometer, at 23° C. and 20 rpm, using the spindles customarily used by the skilled person for the respective viscosity range).

The polyvinyl esters preferably have glass transition temperatures Tg of preferably −20° C. to +40° C., more preferably −10° C. to +30° C., very preferably of 0° C. to +15° C., and most preferably of +1° C. to +10° C. The monomer selection and/or the selection of the weight fractions of the comonomers are made such as to result in the aforesaid glass transition temperatures Tg. The glass transition temperature Tg of the polymers is determined using a Mettler-Toledo DSC1 dynamic scanning calorimeter in an open crucible at a heating rate of 10 K/min. The midpoint of the glass transition during the 2^{nd} heating cycle is evaluated. The Tg may also be calculated approximately in advance using the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (wt %/100) of the monomer n, and Tgₙ is the glass transition temperature in kelvins of the homopolymer of the monomer n. Tg values for homopolymers are listed in Polymer Handbook 2nd Edition, J. Wiley & Sons, New York (1975).

The polyvinyl esters are preferably prepared by the emulsion polymerization process. The emulsion polymerization takes place customarily in aqueous medium, i.e., customarily in the absence of organic solvents. In the case of copolymerization of gaseous comonomers such as ethylene, 1,3-butadiene, or vinyl chloride, operation may also take place under pressure, generally of between 5 bar and 100 bar, preferably between 65 and 80 bar. The polymerization temperature is generally 40° C. to 100° C., preferably 50° C. to 80° C., and more preferably 60 to 70° C.

The polymerization is preferably initiated preferably with the redox initiator combinations that are commonplace for emulsion polymerization. Examples of suitable oxidation initiators are the sodium, potassium, and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide, azobisisobutyronitrile. Particular preference is given to the sodium, potassium, and ammonium salts of peroxodisulfuric acid and to hydrogen peroxide. The stated initiators are used in general in an amount of 0.01 to 2.0 wt %, based on the total weight of the monomers. The stated oxidizing agents, particularly the salts of peroxodisulfuric acid, may also be used alone as thermal initiators.

Examples of suitable reducing agents are the sulfites and bisulfites of the alkali metals and of ammonium, such as sodium sulfite, the derivatives of sulfoxylic acid such as zinc or alkali metal formaldehyde-sulfoxylates, as for example sodium hydroxymethanesulfinate (Brüggolit), (iso)ascorbic acid or salts thereof, and mixtures of the salts of 2-hydroxy-2-sulfinatoacetic acid and 2-hydroxy-2-sulfonatoacetic acid with sodium sulfite (FF6). Preference is given to sodium sulfite, sodium bisulfite, and especially (iso)ascorbic acid or the alkali metal (or alkaline earth metal) salts thereof, and to FF6. The amount of reducing agent is preferably 0.015 to 3 wt %, based on the total weight of the monomers.

The polymerization is carried out customarily at pH levels of 9, preferably 2 to 9, and more preferably 3 to 8. The pH can be adjusted using the usual measures, such as acids, bases, or in particular buffers, such as sodium acetate or phosphates.

To control the molecular weight it is possible to use regulator substances during the polymerization. If chain transfer agents are used for regulation, they are employed customarily in amounts between 0.01 to 5.0 wt %, based on the total weight of the monomers to be polymerized, and are metered in separately or else as a premix with reaction components. Examples of such agents are n-dodecyl mercaptan, tert-dodecyl mercaptan, mercaptopropionic acid, methyl mercaptopropionate, isopropanol, and acetaldehyde. With preference no regulator substances are used.

The polymerization may take place, for example, in the presence of the earlier-mentioned polyvinyl alcohols and/or optionally of one or more further protective colloids. Preferably, however, further protective colloids are avoided. The dispersion-based adhesives, and the polyvinyl esters in the form of aqueous dispersions or water-redispersible powders, therefore preferably comprise, other than polyvinyl alcohols, no further protective colloids. Examples of further protective colloids are polyvinylpyrrolidones; polysaccharides in water-soluble form such as starches (amylose and amylopectin), celluloses and their carboxymethyl, methyl, hydroxyethyl, and hydroxypropyl derivatives; proteins such as casein or caseinate, soy protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids and water-soluble copolymers thereof; melamine-formaldehyde sulfonates, naphthalene-formaldehyde sulfonates, and styrene-maleic acid and vinyl ether-maleic acid copolymers.

The polyvinyl alcohols and the further protective colloids, optionally used, are added in total in general in an amount of in total 0.5 to 20 wt %, based on the total weight of the monomers, in the emulsion polymerization.

In the emulsion polymerization process, polymerization may also take place in the presence of emulsifiers. Preferred amounts of emulsifiers are 0 to 7 wt %, more particularly 1 to 7 wt %, based on the total weight of the monomers. With particular preference, however, no emulsifiers are used. Particularly preferred dispersion-based adhesives or polyvinyl esters in the form of aqueous dispersions or powders which are redispersible in water therefore do not comprise any emulsifiers.

Examples of emulsifiers are anionic, cationic, or nonionic emulsifiers. Examples of anionic emulsifiers are alkyl sulfates having a chain length of 8 to 18 C atoms, alkyl or alkylaryl ether sulfates having 8 to 18 C atoms in the hydrophobic radical and up to 40 ethylene oxide or propylene oxide units, alkyl- or alkylarylsulfonates having 8 to 18 C atoms, and full esters and monoesters of sulfosuccinic acid with monohydric alcohols or alkylphenols. Examples of nonionic emulsifiers are alkyl polyglycol ethers or alkylaryl polyglycol ethers having 8 to 40 ethylene oxide units.

The polymerization can be carried out in conventional polymerization reactors, for example in pressure reactors and/or unpressurized reactors. As pressure reactors or unpressurized reactors it is possible to use the conventional, correspondingly dimensioned steel reactors with stirring facility, heating/cooling system, and lines for supplying the reactants and removing the products, respectively. When gaseous monomers are used, such as ethylene, there is preference for use of a pressure reactor and also, optionally, an unpressurized reactor. The preferred operating pressure in the pressure reactor is 3 to 120 bar, more preferably 10 to 80 bar. The preferred operating pressure in the unpressurized reactor is 100 mbar to 5 bar, more preferably 200 mbar to 1 bar.

The polymerization is preferably carried out preferably in batch or semibatch processes, but may also take place in a continuous process.

In the batch or semibatch process, the monomers, for example, may be metered in or introduced as an initial charge in their entirety. A preferred procedure is to include 20 to 100 wt %, more preferably more than 70 wt % of the monomers in the initial charge, based on the total weight, and to meter in the remaining reservoir of monomers at a later point in time during the emulsion polymerization. The metered feeds may be carried out separately (in terms of location and of time), or the components to be metered in may be metered in, all of them or some of them, in pre-emulsified form.

For example, the polyvinyl alcohols and the further optional protective colloids, may be included in their entirety in the initial charge or partly metered in. Preference is given to including at least 25 wt %, more preferably at least 70 wt %, of the polyvinyl alcohols and of any further protective colloids in the initial charge, based in each case on the total amount of polyvinyl alcohols and, where present, of further protective colloids used. Most preferably the polyvinyl alcohols and any further protective colloids are included in their entirety in the initial charge. More particularly, the high-viscosity and/or medium-viscosity polyvinyl alcohols are preferably included in the initial charge in the manner just described.

The initiators, for example, may be either included in their entirety in the initial charge, or else partly metered in. Preferably the initiators are included in their entirety in the initial charge.

With preference a postpolymerization is carried out after the end of the polymerization. In the postpolymerization, remaining amounts of residual monomer are polymerized. The post-polymerization takes place in application of known techniques, generally with redox catalyst initiated postpolymerization.

Volatile compounds, such as residual monomer or impurities as a result of initiator components or other raw materials, may also be removed by distillation or stripping from the aqueous dispersion. In the case of stripping, optionally under reduced pressure, volatile compounds are removed from the dispersions while inert entraining gases, such as air, nitrogen or steam, are passed through or over the product.

The polyvinyl esters obtainable accordingly, in the form of aqueous dispersions, have a solids content of 30 to 75 wt %, preferably of 50 to 60 wt %.

Preference is also given to polyvinyl esters in the form of water-redispersible powders, more particularly in the form of protective colloid-stabilized water-redispersible powders. To prepare the polyvinyl esters in the form of water-redispersible powders, the aqueous dispersions, optionally after addition of protective colloids as a drying aid, are dried, by means of fluidized bed drying, freeze drying or spray drying, for example. The dispersions are preferably spray-dried. The spray-drying takes place in customary spray-drying units, where atomization may take place by means of single, dual or multiple fluid nozzles or using a rotating disk. The exit temperature selected is generally in the range from 45° C. to 120° C., preferably 60° C. to 90° C., depending on the unit, the Tg of the resin, and the desired degree of drying.

In general the drying aid is used in a total amount of 3 to 30 wt %, based on the polymeric constituents of the dispersion.

This means that the total amount of protective colloid before the drying operation is in general to be at least 3 to 30 wt %, based on the polymer fraction; preference is given to using 5 to 20 wt %, based on the polymer fraction.

Examples of suitable drying aids are partly hydrolyzed polyvinyl alcohols; polyvinylpyrrolidones; polysaccharides in water-soluble form such as starches (amylose and amylopectin), celluloses and their carboxymethyl, methyl, hydroxyethyl, and hydroxypropyl derivatives; proteins such as casein or caseinate, soy protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids and the water-soluble copolymers thereof; melamine-formaldehydesulfonates, naphthalene-formaldehydesulfonates, styrene-maleic acid copolymers, and vinyl ether-maleic acid copolymers. Preference is given to polyvinyl alcohols. Particular preference is given to using no protective colloids other than polyvinyl alcohols as drying aids.

In the case of nozzle atomization, an amount of up to 1.5 wt % of antifoam, based on the vinyl acetate copolymers, has frequently proven useful. In order to increase the storage life by improving the blocking stability, particularly in the case of powders with a low glass transition temperature, the powder obtained can be equipped with an antiblocking agent (anticaking agent), preferably at up to 30 wt %, based on the total weight of polymeric constituents. Examples of antiblocking agents are Ca and/or Mg carbonate, talc, gypsum, silica, kaolins, silicates having particle sizes preferably in the range from 10 nm to 10 μm.

The viscosity of the feed for nozzle atomization is adjusted by way of the solids content so as to obtain in general a figure of <500 mPas (Brookfield viscosity at 20 revolutions and 23° C.), preferably <250 mPas. The solids content of the dispersion for nozzle atomization is generally >35%, preferably >45%.

In order to improve the performance properties it is possible for further additives to be added at the nozzle atomization stage. Further constituents, present in preferred embodiments, of dispersion powder compositions are, for example, pigments, fillers, foam stabilizers, and hydrophobizing agents.

The aqueous dispersions or dispersion-based adhesives of the invention preferably have a solids content of 30 to 75 wt %, more preferably 50 to 60 wt %. The remaining fractions preferably comprise water. The amounts of solid and of water add up in total to 100 wt %.

The dispersion-based adhesives comprise preferably at least 40 wt %, more preferably at least 50 wt %, and most preferably 60 wt % of polyvinyl esters. The dispersion-based adhesives comprise preferably not more than 99 wt % and more preferably not more than 95 wt % of polyvinyl esters. The figures in wt % are based in each case on the dry weight of the dispersion-based adhesives.

The dispersion-based adhesives optionally further comprise one or more adjuvants, examples being plasticizers, such as phthalates, benzoates, or adipates, film-forming assistants, such as triacetin or glycols, more particularly butyl glycol, butyl diglycol, butyldipropylene glycol, and butyltripropylene glycol, wetting agents, surfactants in general, thickeners such as polyacrylates, polyurethanes, cellulose ethers, or polyvinyl alcohols, defoamers, tackifiers, or other adjuvants customary in the formulation of adhesives. The proportion of these adjuvants may be, for example, up to 40 wt %, preferably 0 to 25 wt %, more preferably 1 to 15 wt %, very preferably 1 to 10 wt %, and most preferably 1 to 5 wt %, based in each case on the dry weight of the dispersion-based adhesives.

The dispersion-based adhesives may be prepared by methods commonplace for this purpose, in general by mixing of the aforesaid components. The mixing may take place in conventional mixers, such as stirring mechanisms or dissolvers, for example. Mixing preferably takes place at temperatures of 5 to 50° C., more preferably 15 to 40° C., and most preferably 20 to 30° C.

The dispersion-based adhesives of the invention may be used in the commonplace machine application methods for dispersion-based adhesives, such as in nozzle or roll application processes, for example. The dispersion-based adhesives in this case are applied to substrates. Application may take place continuously, in lines, or dotwise. In this context, the dispersion-based adhesives of the invention are suitable for adhesively bonding a variety of substrates, preferably paper, card, wood, fiber materials, coated cartons and also for bonding cellulosic materials to plastics such as polymeric films, examples being polyethylene, polyvinyl chloride, polyamide, polyester, or polystyrene films. The dispersion-based adhesives find use in particular as paper adhesives, packaging adhesives, wood adhesives, and bonding agents for woven and non-woven fiber materials. The dispersion-based adhesives possess particular suitability for the adhesive bonding of cellulosic substrates, more particularly paper, card, or cotton fabric, in each case to polymeric films, or for the bonding of polymeric films to one another (film/film bonding).

The dispersion-based adhesives of the invention are extremely suitable for application by machine application methods. In this way the incidence of unwanted depositions of adhesive on the application nozzle, or of uncontrolled “splashes”, can be avoided to the extent desired with the dispersion-based adhesives of the invention. The dispersion-based adhesives exhibit advantageous rheological properties, such as low shear thinning. With the dispersion-based adhesives of the invention it is also possible to achieve the rapid setting rate required in the case of machine methods. The dispersion-based adhesives are also stable in storage. A further surprise was that in the procedure according to the invention, there is no need to add emulsifiers to the dispersion-based adhesives or polyvinyl ester dispersions, and the desired performance properties can nevertheless be achieved.

The examples which follow serve for further elucidation of the invention.

The Höppler viscosities reported below for polyvinyl alcohols were determined at 20° C. in 4% strength aqueous solution to DIN 53015. The Brookfield viscosities (BF20) of the aqueous polyvinyl ester dispersions were determined at the particular reported solids content at 23° C. with a Brookfield viscometer at 20 rpm.

### INVENTIVE EXAMPLE 1 (EX. 1)

A pressure reactor having a volume of 600 liters was charged with the following components:

115 kg of water,

66 kg of a 10% strength aqueous solution of polyvinyl alcohol with a degree of hydrolysis of 88% and a Höppler viscosity of 23 mPas for a 4% strength aqueous solution (523),

11 kg of an 8.5% strength aqueous solution of the polyvinyl alcohol with a degree of hydrolysis of 88% and a Höppler viscosity of 40 mPas for a 4% strength aqueous solution (540), 25 kg of a 20% strength aqueous solution of the polyvinyl alcohol with a degree of hydrolysis of 88% and a Höppler viscosity of 5 mPas for a 4% strength aqueous solution (205), 240 g of 98% formic acid,

140 g of iron(II) ammonium sulfate solution (10% strength in water).

The pressure reactor was evacuated and then 200 kg of vinyl acetate were added to the initial charge. Thereafter the reactor was heated to 50° C. and subjected to an ethylene pressure of 40 bar (corresponding to an amount of 43 kg of ethylene).

The polymerization was commenced by starting the feed of a 3% strength aqueous hydrogen peroxide solution at a rate of 350 g/h and of a 10% strength aqueous Na hydroxymethane-sulfinate solution (Brüggolit) at a rate of 480 g/h. Together with the start of polymerization, the temperature was raised from 50° C. to 70° C. 60 minutes after the start of polymerization, vinyl acetate was metered in at a rate of 23 kg/h for 1.5 hours. After the end of the vinyl acetate feed, the metered feeds of the hydrogen peroxide solution and of the Na hydroxymethanesulfinate solution were continued for a further 60 minutes. The total polymerization time was 3.5 hours.

The resulting polymer dispersion was subsequently transferred to an unpressurized reactor. The unpressurized reactor was subjected to a pressure of 0.7 mbar. In the unpressurized reactor, 880 g of a 10% strength aqueous tert-butyl hydroperoxide solution and 580 kg of an aqueous 10% strength Na hydroxymethanesulfinate solution (Brüggolit) were introduced, and postpolymerization was carried out. The pH was adjusted to 4.5 by addition of aqueous sodium hydroxide solution (10% strength). Lastly the batch was filtered using a sieve having a mesh size of 150 μm.

The properties of the polymer dispersion are listed in table 1.

### INVENTIVE EXAMPLES 2 TO 4 (EX. 2 to 4)

The polymerization takes place in the same way as for inventive example 1, using the polyvinyl alcohol compositions specified in table 1.

The properties of the polymer dispersions are set out in table 1.

### COMPARATIVE EXAMPLE 5 (CEX. 5)

A pressure reactor having a volume of 600 liters was charged with the following components:

125 kg of water,

66 kg of a 10% strength aqueous solution of polyvinyl alcohol having a degree of hydrolysis of 88% and a Höppler viscosity of a 4% strength aqueous solution of 23 mPas (523),

25 kg of a 20% strength aqueous solution of polyvinyl alcohol having a degree of hydrolysis of 88% and a Höppler viscosity of a 4% strength aqueous solution of 5 mPas (205),

240 g of 98% strength formic acid,

140 g of iron(II) ammonium sulfate solution (10% strength in water).

The pressure reactor was evacuated and then 200 kg of vinyl acetate were added to the initial charge. Thereafter the reactor was heated to 50° C. and charged with an ethylene pressure of 40 bar (corresponding to an amount of 43 kg of ethylene).

The polymerization was initiated by commencement of the metering of a 3% strength aqueous hydrogen peroxide solution at a rate of 350 g/h and of a 10% strength aqueous Na hydroxymethanesulfinate solution (Brüggolit) at a rate of 480 g/h. With the start of polymerization, the temperature was increased from 50° C. to 70° C. 60 minutes after the start of polymerization, vinyl acetate was metered in at a rate of 23 kg/h for 1.5. After the end of the metering of vinyl acetate, the metered additions of the hydrogen peroxide solution and of the Na hydroxymethanesulfinate solution were continued for 60 minutes more. The total polymerization time was 3.5 hours.

The resulting polymer dispersion was subsequently transferred to an unpressurized reactor. A pressure of 0.7 mbar was applied to the unpressurized reactor. Introduced into the unpressurized reactor were 880 g of a 10% strength aqueous tert-butyl hydroperoxide solution and 580 kg of an aqueous 10% strength Na hydroxymethanesulfinate solution (Brüggolit), and post-polymerization was carried out. The pH was adjusted to 4.5 by addition of aqueous sodium hydroxide solution (10% strength).

Lastly the batch was filtered with a sieve having a mesh size of 150 μm.

The properties of the polymer dispersion are set out in table 1.

### COMPARATIVE EXAMPLE 6 (CEX. 6)

The polymerization takes place in the same way as for comparative example 5, using the polyvinyl alcohol compositions specified in table 1.

The properties of the polymer dispersions are set out in table 1.

TABLE 1
Properties of the polymer dispersions:

| | Polyvinyl alcohol | | | Solids | | |
|---|---|---|---|---|---|---|
| | 205^{a)} | 523^{b)} | 540^{c)} | content | BF20 | |
| | [wt %]^{d)} | [wt %]^{d} | [wt %]^{d)} | [%] | [mPas] | pH |
| Ex. 1 | 2.1 | 2.8 | 0.4 | 55.1 | 14 880 | 5.2 |
| Ex. 2 | 2.1 | 3.0 | 0.2 | 54.4 | 12 540 | 5.0 |
| Ex. 3 | 2.1 | 2.7 | 0.3 | 55.2 | 11 000 | 4.5 |
| Ex. 4 | 2.7 | 2.1 | 0.3 | 56.1 | 15 000 | 4.5 |
| CEx. 5 | 2.1 | 2.8 | 0 | 55.4 | 7200 | 4.3 |
| CEx. 6 | 2.1 | 3.1 | 0 | 55.1 | 8760 | 4.5 |

^{a)}Polyvinyl alcohol with a degree of hydrolysis of 88 mol % and a Hoppler viscosity of 5 mPas;
^{b)}Polyvinyl alcohol with a degree of hydrolysis of 88 mol % and a Hoppler viscosity of 23 mPas;
^{c)}Polyvinyl alcohol with a degree of hydrolysis of 88 mol % and a Hoppler viscosity of 40 mPas;
^{d)}Amounts in wt % are based on the total amount of vinyl acetate used.

Nozzle Application Method: Determination of Web Buildup:

The dispersion-based adhesives were applied by nozzle application to a rotating stainless steel roll.

The stainless steel roll had a circumference of 80 cm and rotated about its own axis at a speed of 120 or 140 revolutions/min (rpm).

The dispersion-based adhesives were applied using an HHS application system with valves of type GKD4-114-2m and nozzles of type LVK-4. The nozzles were mounted perpendicularly above the roll surface at a distance of 4 mm. The dispersion-based adhesives were adjusted to a viscosity of 800 mPas by dilution with water and were supplied to the nozzles via hose lines, by means of a piston pump, using a pressure of 9 bar. The application of the dispersion-based adhesives through the nozzles onto the stainless steel roll was pulsed, with the nozzles being opened and closed again at a constant rate. One cycle of single opening and closing of the nozzle is referred to as a pulse. 18 pulses of the nozzle per rotation of the stainless steel roll were set. The dispersion-based adhesives were straightaway scraped from the stainless steel roll with a plastic scraper.

Testing took place under standard conditions at 23° C. and a relative humidity of 50%.

120 minutes after the beginning of nozzle application, a measurement was made of the size of the conical buildup (web buildup) on the nozzle. The results of the testing are set out in table 2.

If the conical buildup almost reached the surface of the roll before 120 minutes had elapsed, testing was discontinued and the measurement value reported was >4 mm.

TABLE 2
Result of testing:

Web buildup [mm]

| | at 120 rpm | at 140 rpm |
|---|---|---|
| Ex. 1 | 2 | 2.5 |
| Ex. 2 | 3 | 3.5 |
| Ex. 3 | 2.5 | 3 |
| Ex. 4 | 1.5 | 2 |
| CEx. 5 | >4 | >4 |
| CEx. 6 | >4 | >4 |

In the case of inventive examples 1 to 4, the web buildup for all speeds tested (120 rpm, 140 rpm) after the application time of 120 minutes is not more than 3.5 mm, whereas the comparative examples 5 and 6 reach an inadequate maximum value of 4 mm after less than 120 minutes, meaning that nozzle application had to be discontinued. Accordingly, in terms of their stability for nozzle application, the dispersion-based adhesives of the invention are significantly more advantageous relative to the comparative examples.

1.-9. (canceled)

10. In a method for applying adhesives in the form of aqueous dispersions by a machine application method, the improvement comprising applying as an adhesive, an aqueous dispersion of one or more polyvinyl esters and optionally one or more additives wherein the polyvinyl esters are stabilized with at least two polyvinyl alcohols,
at least one polyvinyl alcohol being a high-viscosity polyvinyl alcohol having a viscosity of 36 to 60 mPas, and
at least one polyvinyl alcohol being a medium-viscosity polyvinyl alcohol having a viscosity of 19 to 35 mPas,
wherein the polyvinyl alcohol viscosities are determined by the Höppler method of DIN 53015, at 20° C., in 4% strength aqueous solution.

11. An aqueous dispersion or water-redispersible polymer powder comprising one or more polyvinyl esters, wherein at least one polyvinyl ester is obtained by radically initiated polymerization of monomers selected from the group consisting of:
a) one or more vinyl esters,
optionally b1) one or more olefins,
optionally b2) one or more ethylenically unsaturated monomers selected from the group consisting of (meth)acrylic esters, vinylaromatics, 1,3-dienes, and vinyl halides, and
optionally 0 to 10 wt %, based on the total weight of the monomers, of auxiliary monomers selected from the group consisting of ethylenically unsaturated monocarboxylic and dicarboxylic acids, ethylenically unsaturated carbonitriles, monoesters and diesters of fumaric acid and maleic acid, ethylenically unsaturated sulfonic acids or salts thereof, polyethylenically unsaturated comonomers, epoxide-functional comonomers, silicon-functional comonomers, hydroxyethyl, hydroxypropyl and hydroxybutyl acrylates and methacrylates, diacetoneacrylamide, acetyl-acetoxyethyl acrylate, and acetylacetoxyethyl methacrylate,
where the polyvinyl esters are stabilized with at least two polyvinyl alcohols,
at least one polyvinyl alcohol being a high-viscosity polyvinyl alcohol having a viscosity of 36 to 60 mPas, and
at least one polyvinyl alcohol being a medium-viscosity polyvinyl alcohol having a viscosity of 19 to 35 mPas,
where all medium-viscosity polyvinyl alcohols have a degree of hydrolysis of ≦94%, and from 1 to 30 wt. % of polyvinyl alcohols, based on the total weight of all polyvinyl alcohols, are high-viscosity polyvinyl alcohols, wherein polyvinyl alcohol viscosities are determined by the Höppler method of DIN 53015, at 20° C., in 4% strength aqueous solution.

12. The method for applying adhesives of claim 10, wherein the weight fraction of the high-viscosity polyvinyl alcohols, based on the total weight of the polyvinyl alcohols, is 1 to 30 wt. %.

13. The method for applying adhesives of claim 10, wherein the weight fraction of the medium-viscosity polyvinyl alcohols, based on the total weight of the polyvinyl alcohols, is 30 to 99 wt. %.

14. The aqueous dispersion or water-redispersible polymer powder of claim 11, wherein the weight fraction of the medium-viscosity polyvinyl alcohols, based on the total weight of the polyvinyl alcohols, is 30 to 99 wt. %.

15. The method for applying adhesives of claim 10, wherein the total amount of high-viscosity polyvinyl alcohols and medium-viscosity polyvinyl alcohols is 0.6 to 6 wt. %, based on the dry weight of the polyvinyl esters.

16. The aqueous dispersion or water-redispersible polymer powder of claim 11, wherein the total amount of high-viscosity polyvinyl alcohols and medium-viscosity polyvinyl alcohols is 0.6 to 6 wt. %, based on the dry weight of the polyvinyl esters.

17. The method for applying adhesives of claim 10, wherein the polyvinyl esters are stabilized with at least one high-viscosity polyvinyl alcohol, at least one medium-viscosity polyvinyl alcohol, and at least one low-viscosity polyvinyl alcohol, the low-viscosity polyvinyl alcohol having a viscosity of 1 to 18 mPas determined by the Höppler method according to DIN 53015, at 20° C., in 4% strength aqueous solution.

18. The aqueous dispersion or water-redispersible polymer powder of claim 11, wherein the polyvinyl esters are stabilized with at least one high-viscosity polyvinyl alcohol, at least one medium-viscosity polyvinyl alcohol, and at least one low-viscosity polyvinyl alcohol, the low-viscosity polyvinyl alcohol having a viscosity of 1 to 18 mPas determined by the Höppler method according to DIN 53015, at 20° C., in 4% strength aqueous solution.

19. The method for applying adhesives of claim 17, wherein the fraction of low-viscosity polyvinyl alcohols is up to 60 wt. %, based on the total weight of all polyvinyl alcohols.

20. The aqueous dispersion or water-redispersible polymer powder of claim 11, wherein the fraction of low-viscosity polyvinyl alcohols is up to 60 wt. %, based on the total weight of all polyvinyl alcohols.

21. The method for applying adhesives of claim 10, wherein the adhesives in the form of an aqueous dispersion contain no emulsifier.

22. The aqueous dispersion or water-redispersible polymer powder of claim 11, which contain no emulsifier.

23. The method for applying adhesives of claim 10, wherein the adhesives in the form of an aqueous dispersion are applied by nozzle or roll application methods.
